(19) United States
(12) Patent Application Publication
(10) Pub. No.: US 2026/0319429 A1
(43) Pub. Date: Oct. 15, 2026

(54) IMAGE FORMING APPARATUS

(71) Applicant: CANON KABUSHIKI KAISHA, Tokyo (JP)

(72) Inventors: TOMOOKU KOYAMA, Shizuoka (JP); HIDEKI OHTA, Shizuoka (JP); JIRO MORIYA, Shizuoka (JP)

(21) Appl. No.: 19/573,089

(22) Filed: Mar. 20, 2026

(30) Foreign Application Priority Data
Apr. 9, 2025 (JP) 2025-064147

(51) Int. Cl. G03G 21/16; G03G 15/00

(52) U.S. Cl. CPC G03G 21/1647; G03G 15/6573; G03G 21/1619; G03G 21/1633; G03G 2215/00421; G03G 2221/1639; G03G 2221/1654; G03G 2221/169

(57) ABSTRACT

An image forming apparatus configured to form a toner image on a recording medium includes: a housing; an opening/closing member configured to be openable and closable between a closed position and an open position; a fixing unit; a moving mechanism configured to move the fixing unit from a first position where the fixing unit is housed inside the housing to a second position above the first position in a state where the opening/closing member is at the open position; a discharge tray; and a reading unit provided above the discharge tray. The reading unit is arranged outside a space through which the fixing unit passes when the fixing unit moves from the first position to the second position. In a state where the fixing unit is at the second position, at least a part of the fixing unit is positioned outside the housing.

This application claims the benefit of Japanese Patent Application No. 2025-064147, filed April 9, 2025, which is hereby incorporated by reference herein in its entirety.

### BACKGROUND

### Field of the Technology

The present disclosure relates to an image forming apparatus.

### Description of the Related Art

As image forming apparatuses such as printers, copiers, and all-in-one printers, configurations that include a fixing unit (fixing apparatus) for fixing a toner image onto a recording medium are known.

Japanese Patent Application Laid-open No. 2024-41712 discloses an image forming apparatus including a door that is openable and closable relative to an apparatus main body and a fixing unit capable of moving, in a state where the door is open, from a use position where an image forming operation is performed to a retracted position. The fixing unit is configured to be movable to the retracted position by being held by a rotatable coupling member.

### SUMMARY

The present disclosure is directed to a further advancement of conventional techniques.

According to some embodiments, an image forming apparatus of the present disclosure is characterized by features including:
a housing;
an opening/closing member supported by the housing and configured to be openable and closable between a closed position and an open position;
a fixing unit configured to heat a recording medium on which a toner image has been formed;
a moving mechanism supported by the housing, the moving mechanism being configured to move the fixing unit from a first position where the fixing unit is housed inside the housing to a second position above the first position in a state where the opening/closing member is at the open position;
a discharge tray onto which a recording medium having passed through the fixing unit is loaded; and
a reading unit provided above the discharge tray and configured to read an image on a document, wherein
the reading unit is arranged outside a space through which the fixing unit passes in a case where the fixing unit moves from the first position to the second position, and
in a state where the fixing unit is at the second position, at least a part of the fixing unit is positioned outside the housing.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view of a printer according to a first example.

FIG. 2 is a front view of the printer according to the first example.

FIGS. 3A and 3B are diagrams showing the printer according to the first example in which a door is at an open position.

FIG. 4 is a perspective view of a moving mechanism according to the first example.

FIGS. 5A to 5C are explanatory diagrams of a lock mechanism according to the first example.

FIGS. 6A and 6B are diagrams showing the printer according to the first example in which a fixing apparatus has moved to a retracted position.

FIG. 7 is a diagram showing the printer according to the first example in which a tray unit has been pulled out.

FIG. 8 is a schematic sectional view of a printer according to a second example.

FIG. 9 is a schematic sectional view of a printer according to a third example.

FIG. 10 is a schematic sectional view of a printer according to a fourth example.

FIG. 11 is a schematic sectional view of a printer according to a fifth example.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments. In addition, not all features described in the following embodiments are essential to solutions provided by the disclosure.

### First Example

### Overall Configuration

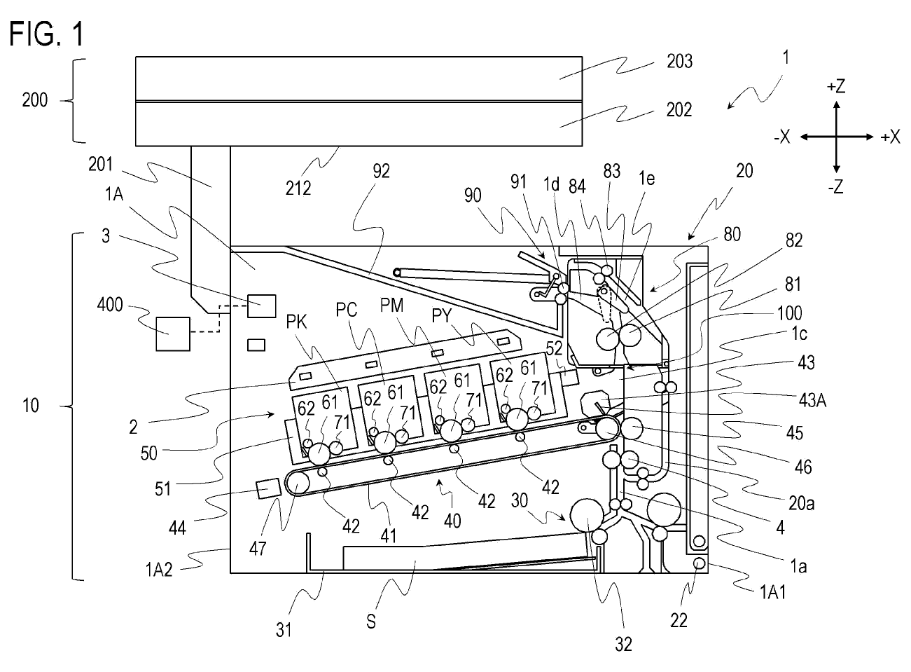

A printer 1 as an image forming apparatus will be described with reference to FIG. 1. FIG. 1 is a schematic sectional view of the printer 1 according to the present example when viewed from a left side of the apparatus. In the present embodiment, the printer 1 is an electrophotographic color laser beam printer that forms images on a sheet S as a recording medium (recording material).

An overall configuration of the printer 1 according to the first example will be described. In the following description, a vertical direction (up-down direction) when the printer 1 is placed on a horizontal surface is defined as a Z-direction. In other words, the Z-direction is a vertical direction when the printer 1 is in a use state. A direction orthogonal to the Z-direction will be defined as an X-direction (first direction). A direction orthogonal to the X-direction and the Z-direction will be defined as a Y-direction. Preferably, the X-direction, the Y-direction, and the Z-direction intersect at right angles to each other. In other words, in the present embodiment, the X-direction and the Y-direction are parallel to a horizontal direction. In the present embodiment, the X-direction is a direction that intersects with (preferably, orthogonal to) a rotational axis direction of a photosensitive drum 61 to be described later. Furthermore, in the present embodiment, the X-direction is a direction that intersects with (preferably, orthogonal to) a rotational axis direction of a rotating member that conveys the sheet S inside a housing 1A. In addition, in the present embodiment, the Y-direction is parallel to the rotational axis direction of the photosensitive drum 61. Furthermore, in the present embodiment, the Y-direction is parallel to the rotational axis direction of the rotating member that conveys the sheet S inside the housing 1A. In addition, for convenience’s sake, in the X-direction, a positive side (right side in FIG. 1) will be referred to as a front side and a negative side (left side in FIG. 1) as a rear side, in the Y direction, a positive side will be referred to as a right side and a negative side as a left side, and in the Z direction, a positive side will be referred to as an upper side and a negative side as a lower side. The front side may be regarded as one end side in the X-direction and the rear side may be regarded as another end side in the X-direction. The right side may be regarded as one end side in the Y-direction and the left side may be regarded as another end side in the Y-direction.

The printer 1 includes a main body portion (apparatus main body, printer main body portion) 10 that forms images on the sheet S and an image scanner 200 that is a reading portion (reading unit) for reading documents. The main body portion 10 is capable of forming an image on the sheet S based on an image of the document table read by the image scanner 200. Hereinafter, a configuration and operations of the main body portion 10 will be described first, followed by a description of a configuration and operations of the image scanner 200. The printer 1 is a so-called all-in-one printer. The image scanner 200 is an example of an upper apparatus installed above the main body portion 10.

The main body portion 10 of the printer 1 has the housing 1A and a door (opening/closing member) 20 that is openable and closable relative to the housing 1A. The housing 1A internally houses a scanner (exposing apparatus) 2, a control portion 3, a sheet feeding portion 30, a transfer unit 40, a tray unit 50, a fixing apparatus (fixing unit) 80, a sheet discharging portion 90, and a moving mechanism 100 for moving the fixing apparatus 80. Hereinafter, in the X-direction, an end portion on the front side of the housing 1A will be defined as a front end portion 1A1 (first end portion) and an end portion on a rear side opposite to the front end portion 1A1 will be defined as a rear end portion 1A2 (second end portion). In the horizontal direction, the +X-direction may be regarded as a direction from the rear end portion 1A2 toward the front end portion 1A1 or a direction away from the rear end portion 1A2. In the horizontal direction, the -X-direction may be regarded as a direction from the front end portion 1A1 toward the rear end portion 1A2 or a direction away from the front end portion 1A1.

The sheet feeding portion 30 has a loading tray 31 for loading sheets S and a supply roller 32. The loading tray 31 is configured to be insertable and extractable to and from the housing 1A, and by pulling out the loading tray 31, a user can refill the sheet S in the loading tray 31. In the first example, the loading tray 31 can be pulled out in a forward direction (+X-direction) from the front end portion 1A1 of the housing 1A.

The tray unit 50 has a tray 51 and cartridges PY, PM, PC, and PK. The tray 51 has a tray handle 52 in a front-side end portion. The cartridges PY, PM, PC, and PK are mounted to the tray 51 so as to be independently detachable, respectively.

The cartridges PY, PM, PC, and PK house yellow (Y), magenta (M), cyan (C), and black (K) toner (developer), respectively. The cartridges PY, PM, PC, and PK share a same configuration with the exception of the colors of toner housed therein. Therefore, the configuration and operations of any one of the cartridges PY, PM, PC, and PK will be described and descriptions of the other cartridges will not be repeated. In addition, when it is not necessary to distinguish among the cartridges PY, PM, PC, and PK, the cartridges PY, PM, PC, and PK may simply be referred to as cartridges.

In the present example, the four cartridges have the photosensitive drum (image bearing member) 61, a charging roller (charging member) 62, and a developing roller (developer bearing member) 71. The respective rotational axis directions of the photosensitive drum 61, the developing roller 71, and the charging roller 62 are all parallel to the Y-direction (left-right direction). While cartridges include the photosensitive drum 61, the charging roller 62, and the developing roller 71 in the present example, a configuration in which the tray 51 includes these members may also be adopted.

The transfer unit 40 has a belt 41, a primary transfer roller 42, a cleaning portion 43, a driver roller 46 that drives the belt 41, and a tension roller (driven roller) 47. An optical sensor 44 that detects a toner image transferred to the belt 41 is arranged in the printer 1 according to the present example. In the present example, the belt 41 is arranged below the photosensitive drum 61. The belt 41 can abut against the photosensitive drum 61 with the primary transfer roller 42 so that a primary transfer portion is formed between the belt 41 and the photosensitive drum 61. In addition, the printer 1 has a secondary transfer roller 45 that abuts against the belt 41 so that a secondary transfer portion is formed. The secondary transfer portion is formed between the belt 41 and the secondary transfer roller 45. The respective rotational axis directions of the primary transfer roller 42, the driver roller 46, the tension roller 47, and the secondary transfer roller 45 are all parallel to the Y-direction. A registration roller pair 4 is arranged on an upstream side of the secondary transfer portion in a conveying direction of the sheet S.

The fixing apparatus 80 is a fixing unit having a fixing roller pair and a flapper 83 that switches the conveying direction of the sheet S to a paper discharge path 1d or a reverse path 1e. The fixing roller pair includes a heating roller 82 that includes a heater and a pressure roller 81 that sandwiches and conveys paper together with the heating roller 82. In the X-direction, the fixing apparatus 80 is closer to the front end portion 1A1 than to the rear end portion 1A2.

### Image Forming Operation

An image forming operation of the printer 1 will be described with reference to FIG. 1. The control portion 3 of the printer 1 starts an image forming operation to the sheet S based on an image signal received from an external host apparatus 400 or the image scanner 200. The external host apparatus 400 is, for example, a personal computer, an image reader, a facsimile, or the like.

When the image forming operation starts, a charging voltage is applied to the charging roller 62 and the photosensitive drum 61 rotates. A laser corresponding to image information is emitted from the scanner 2 to the photosensitive drum 61 and is exposed on a surface of the photosensitive drum 61 having been charged by the charging roller 62. Accordingly, an electrostatic latent image corresponding to the image information is formed on the surface of the photosensitive drum 61.

A developing voltage is applied to the developing roller 71 that bears toner. The electrostatic latent image formed on the photosensitive drum 61 is developed with the toner supplied from the developing roller 71 and a toner image is formed on the surface of the photosensitive drum 61. While the developing roller 71 develops electrostatic latent images in a state where the developing roller 71 abuts against the photosensitive drum 61 in the present example, a configuration may also be adopted in which the developing roller 71 develops electrostatic latent images in a state where a gap is present between the developing roller 71 and the photosensitive drum 61. When a full-color image is formed, a toner image of each color is formed on each photosensitive drum 61.

Note that the developing roller 71 can be switched by a switching apparatus (not illustrated) included in the housing 1A to a state where the developing roller 71 is at an abutting position and a state where the developing roller 71 is at a separation position. In a state where an image forming operation is not performed, the developing roller 71 can be separated from the photosensitive drum 61. In addition, the printer 1 can perform black-and-white print in a state where only the developing roller 71 and the photosensitive drum 61 corresponding to the cartridge PK abut against each other and the developing roller 71 and the photosensitive drum 61 corresponding to the cartridges PY, PM, and PC are separated from each other.

The toner image formed on each photosensitive drum 61 is transferred in the primary transfer portion onto the belt 41 by the primary transfer roller 42 and moved toward the secondary transfer portion formed by the belt 41 and the secondary transfer roller 45.

On the other hand, a conveyance path 1c through which the sheet S directed toward the fixing apparatus 80 passes is formed in the housing 1A, and a duplex conveyance path 20a through which the sheet S having passed through the fixing apparatus 80 subsequently passes is formed inside the door 20. By opening the door 20, the conveyance path 1c and a part of the duplex conveyance path 20a are exposed to the outside of the housing 1A.

The sheet S is separated from a stack of sheets loaded on the loading tray 31 and fed by the supply roller 32 rotating at a predetermined timing in the sheet feeding portion 30, and the sheet S is then conveyed through a paper feeding conveyance path 1a toward the secondary transfer portion.

In the secondary transfer portion, the toner image is transferred from the belt 41 to the sheet S. The toner not transferred to the sheet S is removed from the belt 41 by a cleaning blade (cleaning member) 43A provided inside a cleaning portion 43.

The sheet S to which the toner image was transferred in the secondary transfer portion passes through the conveyance path 1c and conveyed toward the fixing apparatus 80. In the fixing apparatus 80, the sheet S is heated, sandwiched, and pressed by the fixing roller pair and the toner image is fixed to the sheet S. The sheet S to which the toner image has been fixed is conveyed toward the flapper 83 as a conveyance path switching portion.

The flapper 83 is movable to a paper discharge position (solid line in FIG. 1) where the sheet S having passed through the fixing apparatus 80 is guided toward the paper discharge path 1d and to a reverse position (dashed line in FIG. 1) where the sheet S is guided toward the reverse path 1e.

When printing is only performed on one side of the sheet S, the sheet S is guided to the paper discharge path 1d by the flapper 83 and discharged by a discharge roller 91 to a discharge tray 92 formed in an upper portion of the housing 1A. In the present example, the fixing apparatus 80 is positioned on a side of the front end portion 1A1 relative to the discharge tray 92, and the discharge tray 92 and the fixing apparatus 80 are arranged adjacent to each other in the front-to-back direction, with the discharge roller 91 sandwiched therebetween.

When double-side printing is performed, the sheet S having a toner image fixed to one side (surface) is guided to the reverse path 1e by the flapper 83. After the sheet S is guided to the reverse path 1e, the flapper 83 is switched to the paper discharge position, the conveying direction of the sheet S is reversed by a reversing roller 84, and the sheet S passes through the duplex conveyance path 20a formed inside the door 20 and is conveyed once again toward the secondary transfer portion. Subsequently, after a toner image is transferred to the rear surface in the secondary transfer portion, the sheet S once again passes through the fixing apparatus 80, guided to the paper discharge path 1d by the flapper 83, and discharged by the discharge roller 91 to the discharge tray 92. In other words, the sheet S discharged from the inside of the housing 1A by the discharge roller 91 moves in a direction away from the front end portion 1A1 in the horizontal direction. In other words, a discharge direction of the sheet from the housing 1A contains a component away from the front end portion 1A1 in the horizontal direction. Due to the image forming operation described above, the sheet S on which the toner image is formed is sequentially stacked on the discharge tray 92. The supply roller 32, the registration roller pair 4, the belt 41, the secondary transfer roller 45, the fixing roller pair, the discharge roller 91, and the reversing roller 84 are examples of rotating members that convey the sheet S.

### Image Scanner

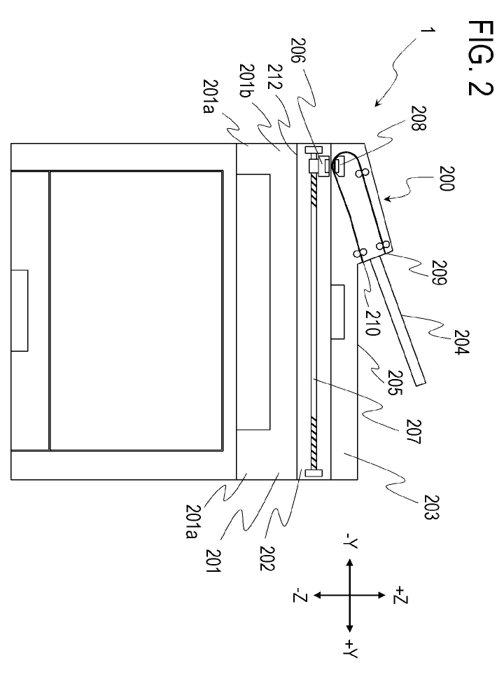

FIG. 2 is a front view of the printer 1 according to the present example when viewed from the front side and is a diagram showing the image scanner 200 provided above the printer 1 in cross-section. The image scanner 200 is a reading unit (reading portion) that has an image reading apparatus 202 and a document feeding apparatus 203.

The image scanner 200 is mounted above the printer 1 via a pillar 201. The pillar 201 is a supporting member that is connected to the rear end portion 1A2 of the housing 1A and supports the image scanner 200. The pillar 201 supports the image scanner 200 so that a lower surface 212 of the image scanner 200 opposes an upper surface of the housing 1A and the discharge tray 92 across a gap. The pillar 201 is mounted to the rear surface of the housing 1A and the lower surface 212 of the image scanner 200, respectively. As shown in FIG. 2, the pillar 201 has a leg portion 201a connected to both end portions in the left-right direction of the rear surface of the housing 1A and a supporting portion 201b that extends from one end portion to another end portion in the left-right direction of the lower surface 212 of the image scanner 200. In the X-direction, the pillar 201 is closer to the rear end portion 1A2 than to the front end portion 1A1. The pillar 201 is arranged downstream of the discharge roller 91 in a discharge direction in which the discharge roller 91 discharges the sheet S to the discharge tray 92.

The image reading apparatus 202 has an image reading portion 206 that reads images of documents and a driving apparatus 207 that drives the image reading portion 206 so as to perform reciprocating scanning in the left-right direction. The document feeding apparatus 203 has a document tray 204 on which documents are loaded, an image reading portion 208 that reads images of the documents, and a document paper discharging portion 205 where documents from which images have been read are discharged. The document feeding apparatus 203 is arranged above the image reading apparatus 202 so that the image reading portion 208 opposes the image reading portion 206 in the vertical direction.

A loading surface of the document tray 204 is inclined upward (+Z-direction) the further toward the right (+Y-direction). A document insertion opening 209 is provided in a left-side (-Y-direction) end portion of the document tray 204, and gravity acts to move the document loaded on the document tray 204 toward the insertion opening 209. In addition, the document loaded on the document tray 204 is conveyed between the image reading portions 206 and 208 arranged so as to oppose each other in the vertical direction on a lower left side of the document tray 204.

The image reading portion 206 is capable of reading a lower surface of the conveyed document and the image reading portion 208 is capable of reading an upper surface of the conveyed document. By having the image reading portions 206 and 208 read surfaces of the document which the image reading portions 206 and 208 oppose, respectively, both sides of the document can be read in a single conveyance of paper. The document having passed between the image reading portions 206 and 208 is discharged from a discharge port 210 to the document paper discharging portion 205. The discharge port 210 is arranged below the insertion opening 209 and on an upper right side of the image reading portions 206 and 208.

In addition, although not illustrated, a contact glass is installed above the image reading portion 206. The document feeding apparatus 203 can be opened relative to the image reading apparatus 202 so as to expose the contact glass. For documents in a booklet form on which the document feeding apparatus 203 cannot be used, the document can be read by loading the document on the contact glass with the document feeding apparatus 203 in the open state and having the driving apparatus 207 reciprocally scan the document with the image reading portion 206. The conveying direction of documents in the image scanner 200 intersects with the conveying direction of the sheet S.

### Movements of Units

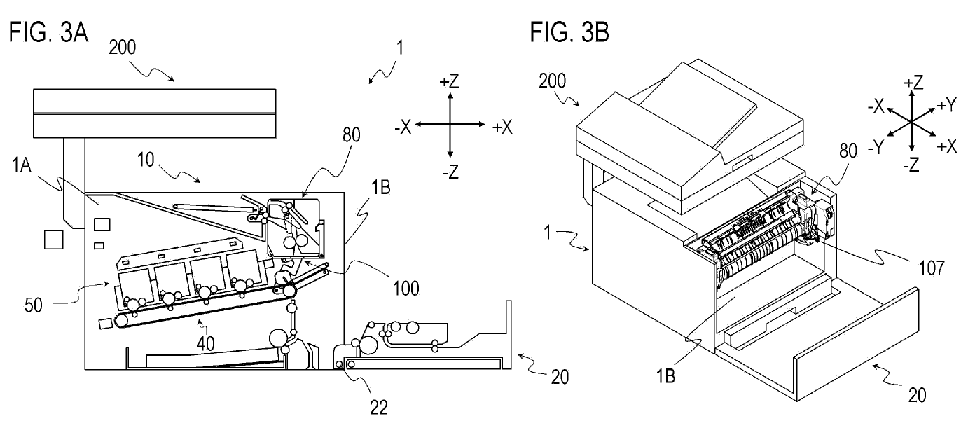

Movements of respective units including the transfer unit 40, the tray unit 50, and the fixing apparatus 80 will be described with reference to FIGS. 3A and 3B, 4, 5A to 5C, 6A and 6B, and 7.

FIGS. 3A and 3B are diagrams showing the printer 1 in which the door 20 is at an open position. FIG. 3A is a schematic sectional view of the printer 1 when viewed from the left side and FIG. 3B is a perspective view of the printer 1. As shown in FIG. 3A, the housing 1A has an opening 1B that opens to the front side and the upper side. The opening 1B is provided in the front end portion 1A1 of the housing 1A. The door 20 that is an opening/closing member is supported by the housing 1A so as to be movable between a closed position shown in FIG. 1 where the door 20 blocks the opening 1B and an open position shown in FIG. 3A where the door 20 opens the opening 1B. The door 20 is rotatable between the closed position and the open position about a door hinge 22 provided at a lower-side end portion and a front-side end portion of the housing 1A. By moving the door 20 to the open position, the user can access the fixing apparatus 80. As shown in FIG. 3B, a release lever 107 to be operated by the user to move the fixing apparatus 80 is provided at a forward (+X-direction) end portion of the fixing apparatus 80.

### Movement of Transfer Unit

First, a movement of the transfer unit 40 will be described. The transfer unit 40 is a pull-out unit configured so as to be capable of being pulled out from an inside position housed within the housing 1A to an outside position where at least a portion of the transfer unit 40 is positioned outside the housing 1A through the opening 1B. In the state shown in FIG. 3A, the transfer unit 40 can be independently pulled forward (+X-direction) out of the housing 1A relative to the tray unit 50 and removed. By pulling out the transfer unit 40 in the forward direction, at least a portion of the transfer unit 40 can be exposed to the outside of the housing 1A and the transfer unit 40 can be removed from the printer 1. In addition, in place of the removed transfer unit 40, a new transfer unit 40 can be inserted into the housing 1A and mounted to the housing 1A to replace the transfer unit 40.

### Movement of Fixing Apparatus

Next, a movement of the fixing apparatus 80 (fixing unit) will be described. The fixing apparatus 80 is configured to be movable, in a state where the door 20 is at the open position, between a fixing position (first position) shown in FIG. 3A and a retracted position (second position) which is above and to the front of the fixing position. The fixing position is a position of the fixing apparatus 80 when an image forming operation with respect to the sheet S is performed and may be regarded as a position of the fixing apparatus 80 when a fixing operation of the toner image to the sheet S is performed by the fixing apparatus 80. The fixing position can also be considered a use position of the fixing apparatus 80. The fixing apparatus 80 is moved from the fixing position where a fixing operation is performed to the retracted position in order to move the tray unit 50. The door 20 at the closed position restricts the fixing apparatus 80 from moving from the fixing position to the retracted position. On the other hand, by positioning the door 20 at the open position, the fixing apparatus 80 is allowed to move from the fixing position to the retracted position. In the first example, the retracted position is a position above the fixing position. In addition, in the X-direction, the retracted position is a position farther away from the rear end portion 1A2 than the fixing position. The housing 1A is provided with the moving mechanism 100 as a mechanism for moving the fixing apparatus 80. In the X-direction, the fixing apparatus 80 at the fixing position is closer to the front end portion 1A1 than to the rear end portion 1A2. In addition, in the X-direction, the fixing apparatus 80 at the retracted position is closer to the front end portion 1A1 than to the rear end portion 1A2.

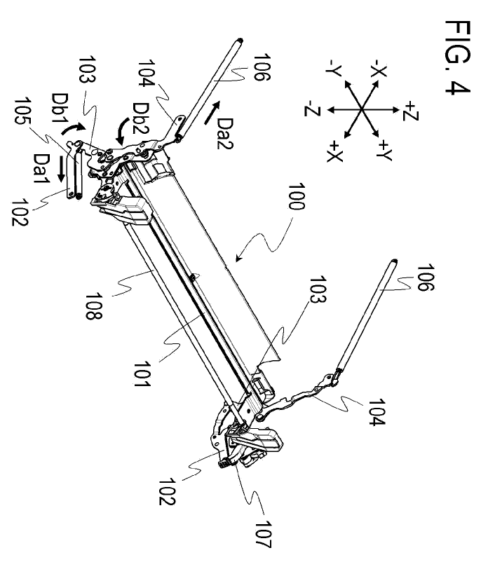

FIG. 4 is a perspective view of the moving mechanism 100. The moving mechanism 100 has a supporting member 101 (abutting member) that abuts against the fixing apparatus 80 from below and supports the fixing apparatus 80 when moving the fixing apparatus 80. The supporting member 101 includes an abutting surface elongated in the left-right direction that abuts against the lower surface (bottom surface) of the fixing apparatus 80. When the fixing apparatus 80 moves to the retracted position, the lower surface of the fixing apparatus 80 is supported by the supporting member 101. When the door 20 is at the closed position and the fixing apparatus 80 is at the fixing position, the bottom surface of the fixing apparatus 80 and the abutting surface of the supporting member 101 are separated from each other by a separation mechanism (not illustrated).

The moving mechanism 100 has a plurality of arm members that are supported by the supporting member 101 and the housing 1A and configured to be capable of moving the supporting member 101 relative to the housing 1A. The plurality of arm members are members for moving the supporting member 101 together with the fixing apparatus 80 and include two lower arms 102, two central arms 103, and two upper arms 104. The three types of arm members (lower arm 102, central arm 103, and upper arm 104) are movably coupled to each other and are provided at each of end portions in a longitudinal direction of the supporting member 101.

The central arms 103 are connected to both end portions of the supporting member 101. In addition, end portions of the lower arms 102 and end portions of the upper arms 104 are connected to the central arms 103. The lower arms 102 and the upper arms 104 are connected to the housing 1A, respectively. The lower arms 102 and the upper arms 104 are configured to be pivotable about a pivot axis parallel to the left-right direction (Y-direction) with respect to the housing 1A, respectively. As the lower arms 102 and the upper arms 104 pivot, the supporting member 101 moves relative to the housing 1A via the central arms 103.

The moving mechanism 100 includes a plurality of biasing members that impart a biasing force in a direction that causes the fixing apparatus 80 to move from the fixing position to the retracted position. One end of a lower lift spring 105 is connected to the lower arms 102. The lower lift spring 105 is a tension spring (biasing member) of which one end is hooked onto the lower arms 102 and another end is hooked onto the housing 1A. In addition, one end of an upper lift spring 106 is connected to the upper arms 104. The upper lift spring 106 is a tension spring (biasing member) of which one end is hooked onto the upper arms 104 and another end is hooked onto the housing 1A.

The lower lift spring 105 biases the lower arms 102 in a first biasing direction Da1. The first biasing direction Da1 is a direction that causes the lower arms 102 to pivot in a first pivot direction Db1. In addition, the upper lift spring 106 biases the upper arms 104 in a second biasing direction Da2. The second biasing direction Da2 is a direction that causes the upper arms 104 to pivot in a second pivot direction Db2. As the lower arms 102 pivot in the first pivot direction Db1 and the upper arms 104 pivot in the second pivot direction Db2, the central arms 103 and the supporting member 101 move upward and forward relative to the housing 1A. In addition, the fixing apparatus 80 moves from the fixing position to the retracted position while being supported by the supporting member 101.

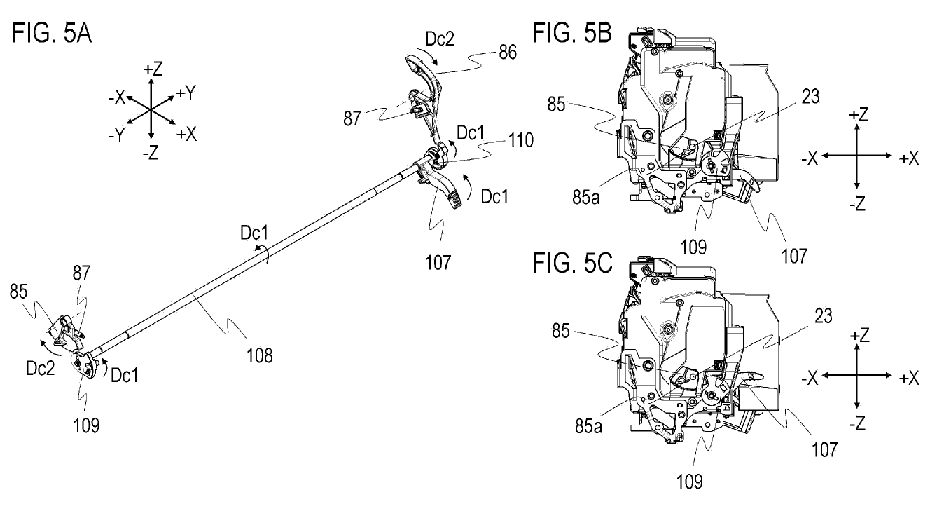

FIGS. 5A to 5C are explanatory diagrams of a lock mechanism that locks the fixing apparatus 80 to the fixing position. FIG. 5A is a perspective view of the lock mechanism. As the lock mechanism, the fixing apparatus 80 has lock members 85 and 86 and a lock spring 87. On the other hand, the moving mechanism 100 has the release lever 107, a link shaft 108, and cam members 109 and 110 as a lock release portion for releasing the lock applied by the lock mechanism.

The lock member 85 is provided at an end portion on the left side (-Y-direction side) of the fixing apparatus 80, and the lock member 86 is provided at an end portion on the right side (+Y-direction side) of the fixing apparatus 80. The lock members 85 and 86 are both held so as to be pivotable about a pivot axis parallel to the left-right direction relative to a main body portion including a housing of the fixing apparatus 80. In addition, the lock spring 87 is mounted to the lock members 85 and 86. The lock spring 87 is a tension spring (biasing member) of which one end is hooked onto the lock member 85 or the lock member 86 and another end is hooked onto the main body portion of the fixing apparatus 80. The lock spring 87 biases the lock members 85 and 86 in a direction in which the fixing apparatus 80 is locked to the fixing position.

The link shaft 108 is a shaft elongated in the left-right direction (Y-direction) and is configured to be rotatable about a rotational axis parallel to the left-right direction. The release lever 107 and the cam member 110 are mounted to a right-side end portion of the link shaft 108 and the cam member 109 is mounted to a left-side end portion of the link shaft 108. The release lever 107 and the cam members 109 and 110 are coupled to the link shaft 108 so as to integrally rotate (pivot) with the link shaft 108.

FIG. 5B is a side view of the fixing apparatus 80 and the lock mechanism in a state where the fixing apparatus 80 is fixed to the fixing position as viewed from a left side. The housing 1A is provided with a shaft 23 that protrudes in the left-right direction as a restricting portion capable of restricting the fixing apparatus 80 from inadvertently moving from the fixing position. In a state where the fixing apparatus 80 is at the fixing position, the shaft 23 that is a restricting portion abuts against an abutted portion 85a that is a restricted portion of the lock member 85 from above and the lock member 85 engages with the shaft 23. In this state, upward movement of the lock member 85 (fixing apparatus 80) is restricted and the fixing apparatus 80 is locked to the fixing position. Note that, although not illustrated, the housing 1A is provided with a similar shaft to the shaft 23 on the right-side end portion where the lock member 86 is provided and upward movement of the lock member 86 is restricted.

FIG. 5C is a side view of the fixing apparatus 80 and the lock mechanism in a state where the release lever 107 has been rotated in a rotation direction Dc1 from the state shown in FIG. 5B and the lock has been released as viewed from the left side. When the release lever 107 moves upward and rotates in the rotation direction Dc1, the link shaft 108 and the cam members 109 and 110 also rotate in the rotation direction Dc1, the cam member 110 abuts against the lock member 85, and the cam member 109 abuts against the lock member 86. In addition, as each cam member presses each lock member, the lock members 85 and 86 rotates in a third pivot direction Dc2. Consequently, the abutted portion 85a of the lock member 85 separates from the shaft 23 and the engagement between the lock member 85 and the shaft 23 is released. At this point, the abutted portion 85a moves to a position where the abutted portion 85a does not overlap with the shaft 23 in a movement direction of the fixing apparatus 80 from the fixing position to the retracted position. Note that a lock release operation of the lock member 86 is similar to that of the lock member 85. In addition, by rotating the release lever 107 in the rotation direction Dc1, the lock of the fixing apparatus 80 by the lock mechanism is released and the fixing apparatus 80 is able to move to the retracted position. In this manner, the moving mechanism 100 includes the lock release portion configured to be capable of pressing the lock member 85 in a direction in which the abutted portion 85a (restricted portion) separates from the shaft 23 (restricting portion).

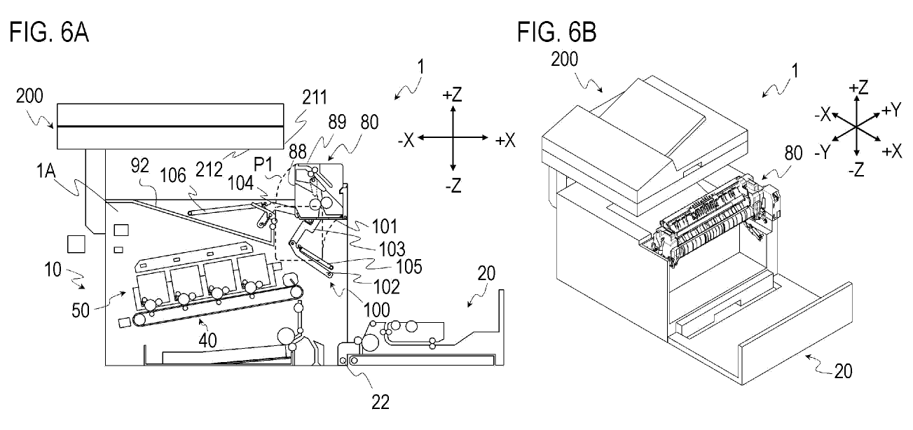

FIGS. 6A and 6B are diagrams showing the printer 1 in which the fixing apparatus 80 has moved to the retracted position. FIG. 6A is a schematic sectional view of the printer 1 when viewed from the left side and FIG. 6B is a perspective view of the printer 1. When the release lever 107 is operated and the lock on the fixing apparatus 80 is released, the biasing forces of the lower lift spring 105 and the upper lift spring 106 cause the moving mechanism 100 to move the fixing apparatus 80 from the fixing position (position in FIGS. 3A and 3B) to the retracted position (position in FIGS. 6A and 6B).

FIG. 6A shows the fixing position of the fixing apparatus 80 and a space P1 (trajectory) through which the fixing apparatus 80 passes when moving from the fixing position to the retracted position. The fixing apparatus 80 moves from the fixing position to the retracted position via the opening 1B of the housing 1A. The retracted position is a position that is above and to the front of the fixing position and where at least a part of the fixing apparatus 80 is arranged outside the housing 1A. Specifically, at least a part of the fixing apparatus 80 at the retracted position is positioned outside of the main body portion 10. Here, if a space enclosed by the housing 1A and the door 20 at the closed position is defined as an internal space of the main body portion 10, the outside (outside space) of the main body portion 10 refers to a space positioned outside of the internal space. In the present example, when the fixing apparatus 80 is at the retracted position, a part of the fixing apparatus 80 is positioned in a space above the housing 1A.

A rear surface 88 of the fixing apparatus 80 at the fixing position is positioned to the front (downstream side in the +X-direction) of a front surface 211 (front-side end surface) of the image scanner 200. In addition, an upper surface 89 (upper-side end surface) of the fixing apparatus 80 at the fixing position is positioned below (downstream side in the-Z-direction) of the lower surface 212 (lower-side end surface) of the image scanner 200. The rear surface 88 is a surface facing the -X-direction and includes a downstream end of the fixing apparatus 80 in the -X-direction. In other words, the rear surface 88 includes a portion closest to the rear end portion 1A2 in the fixing apparatus 80 in the -X-direction. The upper surface 89 is a surface facing the +Z-direction and includes a downstream end of the fixing apparatus 80 in the +Z-direction. In other words, the upper surface 89 includes a highest portion in the fixing apparatus 80 in the vertical-direction. The front surface 211 and the lower surface 212 are external surfaces of the image scanner 200. The front surface 211 is a surface facing the +X-direction and includes a downstream end portion of the image scanner 200 in the +X-direction. The lower surface 212 is a surface facing the -Z-direction and includes a downstream end portion of the image scanner 200 in the -Z-direction. In other words, when the fixing apparatus 80 is at the fixing position, gaps are present between the fixing apparatus 80 and the image scanner 200 in the front-back direction and in the vertical direction.

In addition, the image scanner 200 positioned above the housing 1A is arranged outside the space P1 that is a motion trajectory of the fixing apparatus 80. Therefore, the movement of the fixing apparatus 80 is not impeded by the image scanner 200 and the fixing apparatus 80 during movement or after movement will not interfere with the image scanner 200.

When moving the fixing apparatus 80 to the fixing position from the retracted position, the fixing apparatus 80 need only be moved against the biasing forces of the lower lift spring 105 and the upper lift spring 106. As the user pushes the fixing apparatus 80 at the retracted position downward and rearward, the fixing apparatus 80 moves to the fixing position and is locked by the lock mechanism.

According to the configuration of the present example, the fixing apparatus 80 can be moved between the fixing position and the retracted position without moving the image scanner 200 provided above the housing 1A. In other words, the image scanner 200 need not be moved for the sole purpose of moving the fixing apparatus 80 between the fixing position and the retracted position. In other words, complexity of the printer 1 can be reduced. In addition, even if the image scanner 200 is configured to be movable, the fixing apparatus 80 can be moved between the fixing position and the retracted position without moving the image scanner 200 from a usable position. In other words, the user's workload when moving the fixing apparatus 80 can be reduced.

In addition, in the X-direction, the pillar 201 is closer to the rear end portion 1A2 than to the front end portion 1A1. Therefore, when moving the fixing apparatus 80 from the retracted position to the fixing position, the movement of the fixing apparatus 80 is not inhibited by the pillar 201.

### Movements of Transfer Unit and Tray Unit

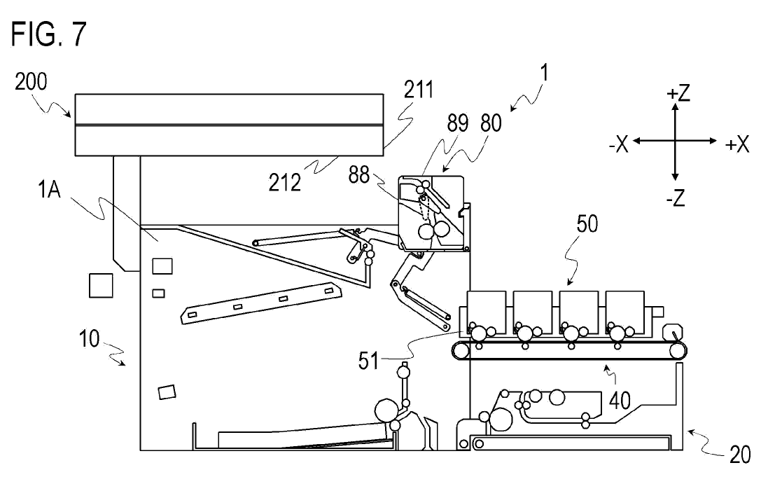

Next, movements of the transfer unit 40 and the tray unit 50 will be described. The tray unit 50 is configured to be movable to the outside of the housing 1A via the opening 1B of the housing 1A together with the transfer unit 40. In other words, the tray unit 50 is also a pull-out unit configured so as to be capable of being pulled out from an inside position housed within the housing 1A to an outside position where at least a portion of the tray unit 50 is positioned outside the housing 1A through the opening 1B. FIG. 7 is a schematic sectional view of the printer 1 in a state where the transfer unit 40 and the tray unit 50 have been pulled out to the outside of the housing 1A as viewed from a left side.

The fixing apparatus 80 at the fixing position is arranged inside a space where the tray unit 50 passes when moving from an inside position to an outside position. On the other hand, the fixing apparatus 80 at the retracted position is arranged outside the space. In other words, the tray unit 50 is pulled out from the inside of the housing 1A to the outside through a space vacated by the movement of the fixing apparatus 80 to the retracted position. In this manner, in the first example, due to the movement of the fixing apparatus 80 to the retracted position, the fixing apparatus 80 retracts from the motion trajectory of the tray unit 50, thereby enabling the tray unit 50 to be pulled out to the outside of the housing 1A.

A movement direction of the transfer unit 40 and the tray unit 50 is a direction intersecting with the rotational axis direction of the photosensitive drum 61, and both units are pulled out from the housing 1A to the front side via the opening 1B. The door 20 at the open position is configured to be capable of supporting, from below, the transfer unit 40 having been pulled out to the outside of the housing 1A. In addition, the tray unit 50 having been pulled out to the outside of the housing 1A is supported by the transfer unit 40 from below.

In a state where the transfer unit 40 and the tray unit 50 have been moved to the outside of the housing 1A, the cartridges PY, PM, PC, and PK can be removed from the tray 51 and the cartridges PY, PM, PC, and PK can be mounted to the tray 51. Accordingly, the cartridges PY, PM, PC, and PK can be replaced with new cartridges PY, PM, PC, and PK.

### Second Example

Next, a second example according to the present disclosure will be described. The second example differs from the first example in a positional relationship between the fixing apparatus 80 and the image scanner 200. Hereinafter, in a configuration of the second example, only differences from the configuration of the first example will be described. In the configuration of the second example, elements similar to the configuration of the first example will be denoted by same reference signs and a description of such elements will not be repeated.

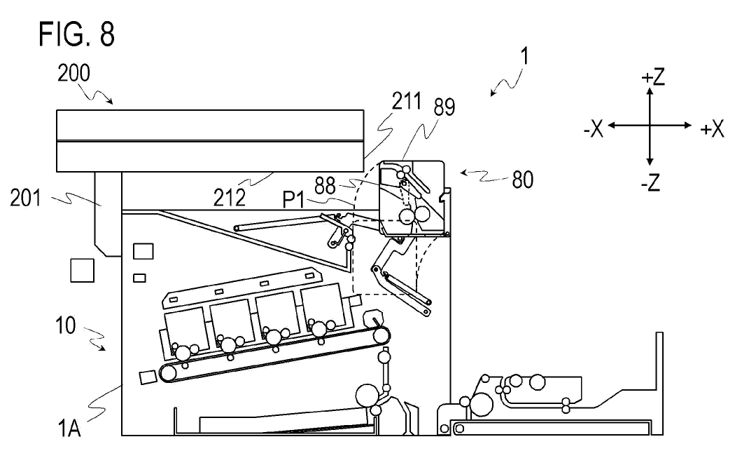

FIG. 8 is a diagram illustrating an overall configuration of the printer 1 according to the second example. FIG. 8 is a schematic sectional view when the printer 1 is viewed from the left side and shows a state where the door 20 is at the open position and the fixing apparatus 80 is at the retracted position.

In the second example, the rear surface 88 of the fixing apparatus 80 at the retracted position is positioned to the front (downstream side in the +X-direction) of the front surface 211 of the image scanner 200. In other words, when the fixing apparatus 80 is at the retracted position, gaps are present between the fixing apparatus 80 and the image scanner 200 in the front-back direction (X-direction). On the other hand, the upper surface 89 of the fixing apparatus 80 at the retracted position is positioned above (downstream side in the +Z-direction) of the lower surface 212 of the image scanner 200. In other words, when viewed in the front-back direction, at least a part (upper end portion) of the fixing apparatus 80 overlaps with the image scanner 200.

According to the configuration of the second example, the image scanner 200 can be arranged at a lower position as compared to the first example. Thereby enabling downsizing of the printer 1 and improved usability of the printer 1. In addition, even in the second example, the image scanner 200 is arranged outside the space P1 that is a motion trajectory of the fixing apparatus 80. In other words, even with the configuration of the second example, the fixing apparatus 80 can be configured to be movable without making the apparatus more complex or larger.

### Third Example

Next, a third example according to the present disclosure will be described. The third example differs from the first example in the positional relationship between the fixing apparatus 80 and the image scanner 200. Hereinafter, in a configuration of the third example, only differences from the configuration of the first example will be described. In the configuration of the third example, elements similar to the configuration of the first example will be denoted by same reference signs and a description of such elements will not be repeated.

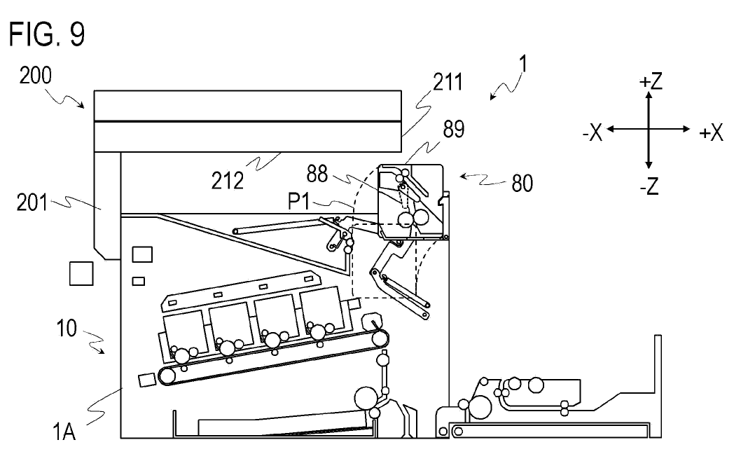

FIG. 9 is a diagram illustrating an overall configuration of the printer 1 according to the third example. FIG. 9 is a schematic sectional view when the printer 1 is viewed from the left side and shows a state where the door 20 is at the open position and the fixing apparatus 80 is at the retracted position.

In the third example, the rear surface 88 of the fixing apparatus 80 at the retracted position is positioned to the rear (upstream side in the +X-direction) of the front surface 211 of the image scanner 200. In other words, with the fixing apparatus 80 at the retracted position, when the printer 1 is viewed in the vertical direction (Z-direction), at least a part (rear end portion) of the fixing apparatus 80 overlaps with the image scanner 200. On the other hand, the upper surface 89 of the fixing apparatus 80 at the retracted position is positioned below (downstream side in the -Z-direction) of the lower surface 212 of the image scanner 200. In other words, a gap is present between the fixing apparatus 80 and the image scanner 200 in the vertical direction.

According to the configuration of the third example, the image scanner 200 can be arranged further to the front as compared to the first example. Thereby enabling an amount by which the image scanner 200 protrudes rearward relative to the housing 1A to be reduced. Consequently, the printer 1 can be downsized and an installation area of the printer 1 can be reduced. In addition, even in the third example, the image scanner 200 is arranged outside the space P1 that is a motion trajectory of the fixing apparatus 80. In other words, even with the configuration of the third example, the fixing apparatus 80 can be configured to be movable without making the apparatus more complex or larger.

### Fourth Example

Next, a fourth example according to the present disclosure will be described. The fourth example differs from the first example in the configuration of the image scanner 200 and the positional relationship between the fixing apparatus 80 and the image scanner 200. Hereinafter, in a configuration of the fourth example, only differences from the configuration of the first example will be described. In the configuration of the fourth example, elements similar to the configuration of the first example will be denoted by same reference signs and a description of such elements will not be repeated.

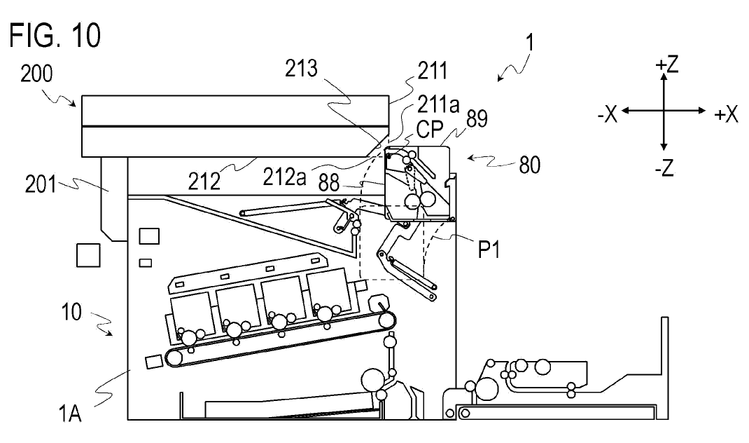

FIG. 10 is a diagram illustrating an overall configuration of the printer 1 according to the fourth example. FIG. 10 is a schematic sectional view when the printer 1 is viewed from the left side and shows a state where the door 20 is at the open position and the fixing apparatus 80 is at the retracted position.

The image scanner 200 according to the fourth example has a connecting surface 213 formed between the front surface 211 that is an end surface on a side of the front end portion 1A1 and the lower surface 212 that is a lower end surface. The connecting surface 213 is an inclined surface that extends downward and rearward from a lower end of the front surface 211 and is connected to a forward end of the lower surface 212. The connecting surface 213 is inclined relative to the front surface 211 and the lower surface 212.

In the fourth example, the rear surface 88 of the fixing apparatus 80 at the retracted position is positioned to the rear of the front surface 211 of the image scanner 200. In other words, with the fixing apparatus 80 at the retracted position, when the printer 1 is viewed in the vertical direction (Z-direction), at least a part of the fixing apparatus 80 overlaps with the image scanner 200. In addition, the upper surface 89 of the fixing apparatus 80 at the retracted position is positioned above the lower surface 212 of the image scanner 200. In other words, when viewed in the front-back direction (X-direction), at least a part of the fixing apparatus 80 overlaps with the image scanner 200.

The front surface 211, the lower surface 212, and the connecting surface 213 are at positions separated from the fixing apparatus 80 at the retracted position and the space P1 that is the motion trajectory of the fixing apparatus and the image scanner 200 does not interfere with the fixing apparatus 80. In addition, when viewed in the left-right direction (Y-direction), an intersection point CP where an imaginary line 211a (extension line) extending downward from the front surface 211 intersects with an imaginary line 212a (extension line) extending forward from the lower surface 212 is at a position overlapping with the fixing apparatus 80. In other words, the fixing apparatus 80 at the retracted position is at a position overlapping with the image scanner 200 having been excluded by the connecting surface 213. Adopting such a configuration enables the image scanner 200 to be arranged closer to the fixing apparatus 80.

According to the configuration of the fourth example, the image scanner 200 can be arranged further below and to the front as compared to the first example. Consequently, the printer 1 can be downsized and usability of the printer 1 can be improved. In addition, even in the fourth example, the image scanner 200 is arranged outside the space P1 that is the motion trajectory of the fixing apparatus 80. In other words, even with the configuration of the fourth example, the fixing apparatus 80 can be configured to be movable without making the apparatus more complex or larger.

Note that while the connecting surface 213 is described to have an inclined surface shape constituted of one surface in the present example, the shape of the connecting surface 213 is not limited thereto. For example, the shape of the connecting surface 213 may be an arc shape constituted of a curved surface or a stepped shape constituted of a plurality of surfaces.

### Fifth Example

Next, a fifth example according to the present disclosure will be described. The fifth example differs from the first example in the configuration of the image scanner 200 and the positional relationship between the fixing apparatus 80 and the image scanner 200. Hereinafter, in a configuration of the fifth example, only differences from the configuration of the first example will be described. In the configuration of the fifth example, elements similar to the configuration of the first example will be denoted by same reference signs and a description of such elements will not be repeated.

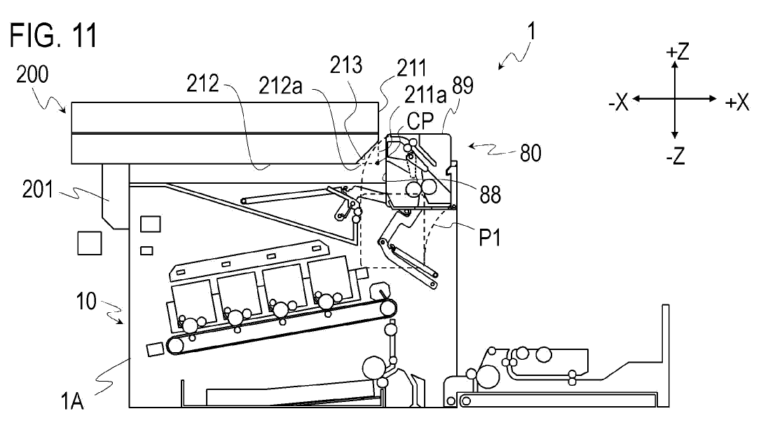

FIG. 11 is a diagram illustrating an overall configuration of the printer 1 according to the fifth example. FIG. 11 is a schematic sectional view when the printer 1 is viewed from the left side and shows a state where the door 20 is at the open position and the fixing apparatus 80 is at the retracted position.

In a similar manner to the fourth example, the image scanner 200 according to the fifth example has the connecting surface 213 formed between the front surface 211 and the lower surface 212. Note that while the connecting surface 213 also has an inclined surface shape constituted of one surface in the present example, the connecting surface 213 may include a curved surface or a plurality of surfaces.

In the fifth example, the rear surface 88 of the fixing apparatus 80 at the retracted position is positioned to the front of the front surface 211 of the image scanner 200. In other words, when the fixing apparatus 80 is at the retracted position, a gap is present between the fixing apparatus 80 and the image scanner 200 in the front-back direction (X-direction). On the other hand, the upper surface 89 of the fixing apparatus 80 at the retracted position is positioned above the lower surface 212 of the image scanner 200. In other words, when viewed in the front-back-direction, at least a part of the fixing apparatus 80 overlaps with the image scanner 200.

The front surface 211, the lower surface 212, and the connecting surface 213 are at positions separated from the fixing apparatus 80 at the retracted position and the space P1 that is the motion trajectory of the fixing apparatus and the image scanner 200 does not interfere with the fixing apparatus 80. In addition, when viewed in the left-right direction, an intersection point CP where the imaginary line 211a extending downward from the front surface 211 intersects with the imaginary line 212a extending forward (+X direction) from the lower surface 212 is positioned inside the space P1. In other words, the fixing apparatus 80 passes through a region of the image scanner 200 having been excluded by the connecting surface 213. Adopting such a configuration increases a degree of freedom of arrangement of the image scanner 200 and enables the image scanner 200 to be arranged closer to the fixing apparatus 80.

According to the configuration of the fifth example, the image scanner 200 can be arranged further below and to the front as compared to the first example. Consequently, the printer 1 can be downsized and usability of the printer 1 can be improved. In addition, even in the fifth example, the image scanner 200 is arranged outside the space P1 that is the motion trajectory of the fixing apparatus 80. In other words, even with the configuration of the fifth example, the fixing apparatus 80 can be configured to be movable without making the apparatus more complex or larger.

### Modification

While examples of the present disclosure have been described above, shapes, relative arrangements, and the like of components described in the examples should be appropriately modified based on the configuration of the apparatuses to which the disclosure applies and various conditions, and do not limit the scope of this disclosure.

For example, while the retracted position of the fixing apparatus 80 is above and to the front of the fixing position in the respective examples described above, the retracted position of the fixing apparatus 80 is not limited to such a configuration. The retracted position of the fixing apparatus 80 need only be a position outside of a space used by the tray unit 50 when moving from an inside position to an outside position and may be a position directly above the fixing position when the fixing apparatus 80 is moved parallel to the vertical direction from the fixing position. In addition, while the image scanner 200 is fixed in the respective examples described above, the image scanner 200 may be configured to be movable.

According to the present disclosure, conventional techniques can be further advanced.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An image forming apparatus configured to form a toner image on a recording medium, the image forming apparatus comprising:
a housing;
an opening/closing member supported by the housing and configured to be openable and closable between a closed position and an open position;
a fixing unit configured to heat a recording medium on which a toner image has been formed;
a moving mechanism supported by the housing, the moving mechanism being configured to move the fixing unit from a first position where the fixing unit is housed inside the housing to a second position above the first position in a state where the opening/closing member is at the open position;
a discharge tray onto which a recording medium having passed through the fixing unit is loaded; and
a reading unit provided above the discharge tray and configured to read an image on a document, wherein
the reading unit is arranged outside a space through which the fixing unit passes in a case where the fixing unit moves from the first position to the second position, and
in a state where the fixing unit is at the second position, at least a part of the fixing unit is positioned outside the housing.

2. The image forming apparatus according to claim 1, wherein
the housing has a first end portion in a first direction parallel to a horizontal direction and a second end portion on an opposite side to the first end portion, and
the fixing unit at the first position is closer to the first end portion than to the second end portion in the first direction.

3. The image forming apparatus according to claim 2, wherein
in a state where the fixing unit is at the second position, a gap is present between the fixing unit and the reading unit in a vertical direction and in the first direction.

4. The image forming apparatus according to claim 2, wherein
in a state where the fixing unit is at the second position, a gap is present between the fixing unit and the reading unit in a vertical direction, and at least a part of the fixing unit overlaps with the reading unit in a case where the fixing unit is viewed in the vertical direction.

5. The image forming apparatus according to claim 2, wherein
in a state where the fixing unit is at the second position, a gap is present between the fixing unit and the reading unit in the first direction, and at least a part of the fixing unit overlaps with the reading unit in a case where the fixing unit is viewed in the first direction.

6. The image forming apparatus according to claim 2, wherein
the reading unit has a lower surface that is a lower end surface in a vertical direction, an end surface on a side of the first end portion in the first direction, and a connecting surface formed between the lower surface and the end surface, and
in a state where the fixing unit is at the second position, at least a part of the fixing unit overlaps with the connecting surface in a case where the fixing unit is viewed in the vertical direction, and at least a part of the fixing unit overlaps with the connecting surface in a case where the fixing unit is viewed in the first direction.

7. The image forming apparatus according to claim 2, wherein
the reading unit has a lower surface that is a lower end surface in a vertical direction, an end surface on a side of the first end portion in the first direction, and a connecting surface formed between the lower surface and the end surface, and
the connecting surface is arranged outside of the space, and in a case where the fixing unit is viewed in a direction that intersects with the vertical direction and the first direction, an intersection point where an imaginary line extending the lower surface intersects with an imaginary line extending the end surface is positioned inside the space.

8. The image forming apparatus according to claim 2, wherein
in a state where the fixing unit is at the first position, the fixing unit is positioned on a side of the first end portion relative to the discharge tray.

9. The image forming apparatus according to claim 2, wherein
the second position is a position farther away from the second end portion than the first position is in the first direction.

10. The image forming apparatus according to claim 2, further comprising:
a supporting member which is connected to the housing and which supports the reading unit, wherein
the supporting member is closer to the second end portion than to the first end portion in the first direction.

11. The image forming apparatus according to claim 10, further comprising:
a discharge roller configured to discharge the recording medium toward the discharge tray, wherein
the supporting member is arranged on a downstream side of the discharge roller in a discharge direction of the discharge roller.

12. The image forming apparatus according to claim 1, further comprising:
a pull-out unit configured so as to be capable of being pulled out from an inside position where the pull-out unit is housed within the housing to an outside position where at least a portion of the pull-out unit is positioned outside the housing, wherein
the fixing unit at the first position is arranged inside a space through which the pull-out unit passes in a case where the pull-out unit moves from the inside position to the outside position, and the fixing unit at the second position is arranged outside the space through which the pull-out unit passes in a case where the pull-out unit moves from the inside position to the outside position.

13. The image forming apparatus according to claim 1, wherein
the moving mechanism includes an abutting member configured to be capable of abutting against the fixing unit from below, an arm member supported by the housing and configured to be capable of moving the abutting member relative to the housing, and a biasing member configured to bias the arm member and causes the abutting member to move in a direction in which the fixing unit heads toward the second position from the first position.

14. The image forming apparatus according to claim 13, wherein
the fixing unit includes a main body portion and a lock member which is configured to be pivotable relative to the main body portion and which has a restricted portion,
the housing has a restricting portion which abuts against the restricted portion from above and which is capable of restricting movement of the fixing unit to the second position in a state where the fixing unit is at the first position, and
the moving mechanism has a lock release portion capable of pressing the lock member in a direction in which the restricted portion separates from the restricting portion.
